(19) United States
(12) Patent Application Publication
(10) Pub. No.: US 2015/0242084 A1
(43) Pub. Date: Aug. 27, 2015

(54) DISPLAY CONTROLLING DEVICE, DISPLAY DEVICE, DISPLAY METHOD AND RECORDING MEDIUM

(71) Applicant: NEC Corporation, Tokyo (JP)

(72) Inventor: Hiroshi TSUKADA, Tokyo (JP)

(73) Assignee: NEC Corporation

(21) Appl. No.: 14/626,162

(22) Filed: Feb. 19, 2015

(30) Foreign Application Priority Data
Feb. 27, 2014 (JP) 2014-036173

(51) Int. Cl. G06F 3/0485; G06F 3/0482; G06F 3/0484

(52) U.S. Cl. CPC G06F 3/0485; G06F 3/04842; G06F 3/0482

(57) ABSTRACT

The display controlling device displays a user-selected item that exists outside of the range that can be displayed on a screen at an end of the screen. The display controlling device includes the display position determination unit which determines the display position of each of items in a display format where, if a selected item is positioned outside of the scrollable displaying area based on the content stored in the display area storage unit, to be displayed by scrolling, the item remains at an end of the scrollable displaying area.

### INCORPORATION BY REFERENCE

This application is based upon and claims the benefit of priority from Japanese Patent Application No. 2014-036173, filed on Feb. 27, 2014, the disclosure of which is incorporated herein in its entirety by reference.

### TECHNICAL FIELD

The present invention relates to a technical field of displaying a plurality of items on a screen.

### BACKGROUND ART

There has been known an art called a screen display where a user can perform operation for selecting some among a plurality of items displayed in a list format. For convenience of explanation, displaying of items on a screen may be herein referred to as a “list view”. The list view is utilized, for example, for displaying a list of files in Windows® Explorer or the like and in functions of a mailer and the like in information processing devices, such as personal computers, tablets, and smartphones. With the screens of mobile terminals, such as tablets and smartphones, the area where the list view can be displayed is limited. For this reason, if the area that is required for displaying items is larger than the area that can display a list view, the terminal limits the items to be displayed at a time using a scroll. Then, the items that have not been displayed exist outside of the screen to be displayed by scrolling.

In order to perform some kind of operation for an item displayed in a list view, a user performs item selecting-operation. At this point, it is important to clearly indicate what is selected by the user. Thus, in a typical list view, for example, the terminal causes the user to understand the selection operation by changing background color of a portion displaying the selected item.

However, if there are many items to be displayed in a list view, the items may not be displayed within a screen. Thus, a scroll may sometimes be required. In such a case, if selected items reside outside of the display range, the user may not see which items are selected or not selected with a glance. In addition, the user might be required to perform scroll operation to see which items are selected or not selected.

The related art that exists prior to the present application is, for example, disclosed in the following patent literature.
Patent Literature 1 (Unexamined Japanese Patent Application Publication No. 2011-118604) discloses a list display controlling device that, when a selected item is not included within the displaying area, displays the item by changing the display order.
Patent Literature 2 (Unexamined Japanese Patent Application Publication No. 2010-019790) discloses an item selection device that applies a repellent force to a scroll bar in a display screen being scrolled so as to facilitate pausing at the position of a selection item.
Patent Literature 3 (Unexamined Japanese Patent Application Publication No. 2001-350463) discloses a graph display controlling device that, when a drawn graph is outside of the display screen, encourages scrolling by displaying a direction mark that indicates a scroll direction that is appropriate for displaying the graph within the display screen.
Patent Literature 4 (Unexamined Japanese Patent Application Publication No. 08-095732) discloses a figure processing device that displays a selected item near the center of a screen to be scrolled.

However, the art proposed in Patent Literature 1 to 4 does not consider a case where a user selects a plurality of items and the display positions thereof are too apart to be simultaneously displayed within a screen.

### SUMMARY

Even if a user selects a plurality of items in a list view, the display controlling device according to the present invention displays the items within a range that can be displayed on a screen in an unchanged order. Further, the major objective of the present invention is to provide a display controlling device and the like that can display items that are selected by a user and outside of the range that can be displayed on the screen at an end of the screen.

To achieve the above-described objective, the display controlling device according to the present invention has the following configuration.

Specifically, the display controlling device according to the present invention

includes:

an item storage unit that stores information relating to a plurality of items included in a display content that can be displayed on a display screen of a screen display device;

a display area storage unit that stores information including a scroll amount according to scrolling operation in a scrollable displaying area for displaying the display content, the scrollable displaying area being displayed on the display screen of the screen display device;

a display position determination unit that determines a display position of each of the items based on information stored in the item storage unit and information stored in the display area storage unit,

wherein the display position determination unit determines the display position of each of the items in a display format where, if an item selected from the items stored in the item storage unit is positioned outside of the scrollable displaying area based on the content stored in the display area storage unit to be displayed by scrolling, the item remains at an end of the scrollable displaying area.

To achieve the objective, the display method according to the present invention is performed by an information processing device, including:

for a display content that can be displayed on a display screen of a screen display device,

according to scroll operation in a scrollable displaying area for displaying the display content the scrollable display area being displayed on the display screen of the screen display device,

determining a display position of an item in a display format where, if the item selected from items included in the display content is positioned outside of the scrollable displaying area to be displayed by scrolling, the item remains at an end of the scrollable displaying area.

Further, the objective will also be achieved by a computer program that causes a computer to realize the display controlling device that has the above-described configuration and by a non-transitory computer-readable recording medium that stores the computer program.

### Advantageous Effect of the Invention

The above-described present invention has an effect where, in the screen on which a plurality of selectable items are displayed, a user can easily see the selected item without additional operation.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of the display controlling device according to a first exemplary embodiment of the present invention;

FIG. 2 is a block diagram showing a configuration of the display device according to a second exemplary embodiment of the present invention;

FIG. 3 is a diagram illustrating the item storage unit according to the second exemplary embodiment of the present invention;

FIG. 4 is a diagram illustrating the display area storage unit according to the second exemplary embodiment of the present invention;

FIG. 5 is a diagram illustrating a concept of display when a list view is scrolled up according to the second exemplary embodiment of the present invention;

FIG. 6 is a diagram illustrating a concept of display when a list view is scrolled down according to the second exemplary embodiment of the present invention;

FIG. 7 is a diagram illustrating a concept of display when there are a plurality of items that are displayed by remaining at the upper end according to the second exemplary embodiment of the present invention;

FIG. 8 is a flowchart that indicates processing of generating a content to be displayed in the display controlling device according to the second exemplary embodiment of the present invention;

FIG. 9 is a flowchart that indicates processing of determining a display position in a display position determination unit according to the second exemplary embodiment of the present invention;

FIG. 10 is a flowchart that indicates processing of determining display positions of selected items in the display position determination unit according to the second exemplary embodiment of the present invention;

FIG. 11 is a flowchart that indicates processing of determining a method of displaying a plurality of items at the upper end and the lower end of the display screen in the display position determination unit according to the second exemplary embodiment of the present invention;

FIG. 12 is a diagram illustrating the item storage unit according to a third exemplary embodiment of the present invention;

FIG. 13 is a diagram illustrating the display area storage unit according to the third exemplary embodiment of the present invention;

FIG. 14 is a diagram illustrating the concept of display according to the third exemplary embodiment of the present invention; and

FIG. 15 is a exemplary diagram illustrating a hardware configuration of a computer (information processing device) that can implement the first, second, and third exemplary embodiments of the present invention.

### EXEMPLARY EMBODIMENT

The following will describe the details of the exemplary embodiments of the present invention with reference to the drawings.

### First Exemplary Embodiment

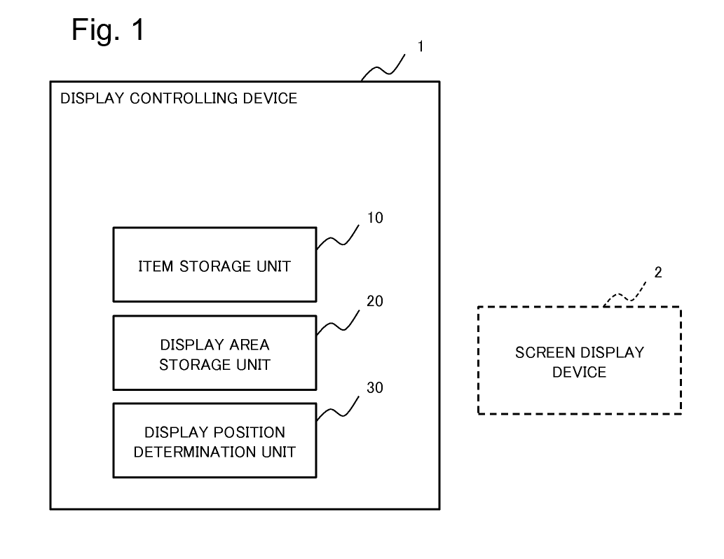

FIG. 1 is a block diagram showing a configuration of the display controlling device according to the first exemplary embodiment of the present invention.

The display controlling device 1 is a device that controls displaying of a content on the display screen (not shown in FIG. 1) of the screen display device 2. For convenience of explanation, the screen display device may be herein referred to as a “display”. Further, for convenience of explanation, the content may be herein referred to as “display information”. The display controlling device 1 has display information that is within a range that can be displayed on the screen (i.e., the display screen) in a displaying area. According to the scroll of the displaying area, the display controlling device 1 determines display information to be displayed on the display screen. In the exemplary embodiments herein, the expression “a screen” includes a case where a plurality of displays are arranged to be used as a screen.

The display controlling device 1 according to the first exemplary embodiment has an item storage unit 10, a display area storage unit 20, and a display position determination unit 30.

The item storage unit 10 stores information relating to a plurality of items among display information.

The display area storage unit 20 stores information including a scroll amount according to scrolling operation in a scrollable displaying area for scrolling a content that can be displayed on the display screen of the screen display device 2.

The display position determination unit 30 determines the display position of an item based on information stored in the item storage unit 10 and information stored in the display area storage unit 20.

If the display position determination unit 30 determines that a selected item from among the items stored in the item storage unit 10 is outside of the scrollable displaying area to be displayed by scrolling based on the content stored in the display area storage unit 20, the display position determination unit 30 performs the following processing. That is, the display position determination unit 30 determines the display position so as to display the item remaining within an end (boundary) of the scrollable displaying area.

As described above, the first exemplary embodiment has an effect where, in the screen on which a plurality of selectable items are displayed, a user can easily see the selected item without additional operation.

This is because the display controlling device 1 according to the first exemplary embodiment continues to display the selected item within the display screen even if a user performs scroll operation. In other words, if a selected item (selection item) exists in the scrollable displaying area, the display controlling device 1 moves the display position of the selection item by scroll operation. Here, if the display position of the selection item contacts with an end of the scrollable displaying area, the display controlling device 1 holds the movement of the display position of the selection item in the contact state. Then, while the display position of the selection item continues to be outside of the scrollable displaying area even if the scroll position is further moved, the display controlling device 1 displays the selection item in a display format as if the selection item sticks to the end of the display screen. In this way, a user can easily see the selected item.

### Second Exemplary Embodiment

Next, the following will describe the second exemplary embodiment on the basis of the display controlling device according to the above-described first exemplary embodiment.

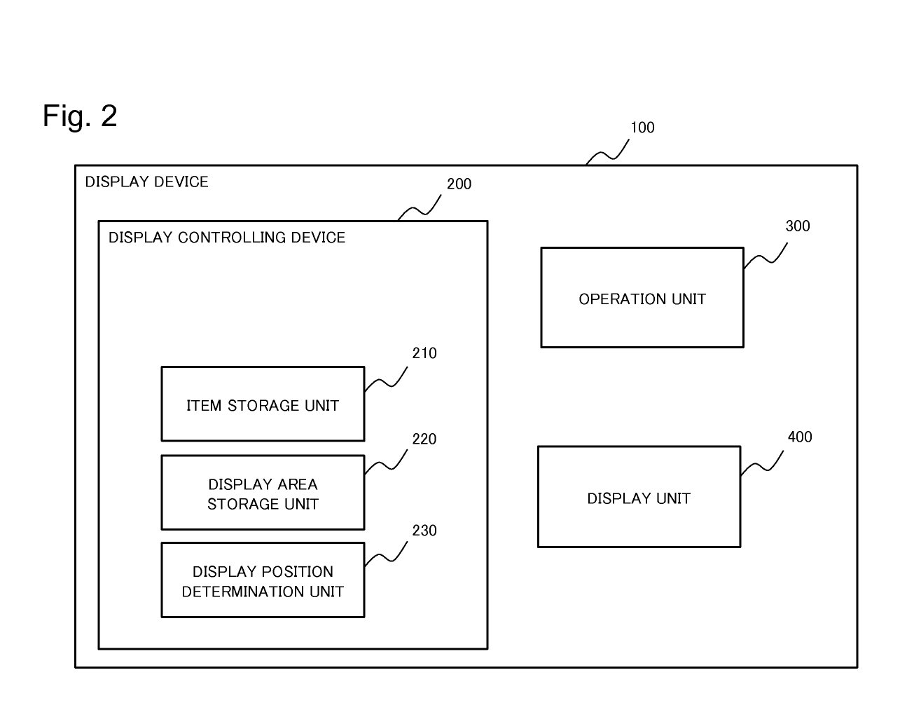

FIG. 2 is a block diagram showing a configuration of the display device according to the second exemplary embodiment of the present invention.

The display device 100 according to the second exemplary embodiment has a display controlling device 200, an operation unit 300, and a display unit 400.

The display controlling device 200 controls the display device 100.

The operation unit 300 informs the display controlling device 200 of, for example, operation that is performed by a user using an input device such as a mouse. The content of the operation may be item selection operation or scroll operation.

The display unit 400 has a display screen, not shown, that displays a content, such as a variety of letters and figures, visually distinguishably to a user and displays a list view corresponding to a scrollable displaying area on the display screen.

The display controlling device 200 includes an item storage unit 210, a display area storage unit 220, and a display position determination unit 230.

The item storage unit 210 stores information relating to the items to be displayed in a list view.

The display area storage unit 220 stores information including a scroll amount according to scrolling the operation in tha scrollable display area for displaying the display content, the scrollable display area being displayed on the display screen.

The display position determination unit 230 determines a position for displaying an item stored in the item storage unit 210 on the display screen.

In the second exemplary embodiment, there will be exemplified a case of running a Web application for displaying a list of mails sent to a user in the display device 100.

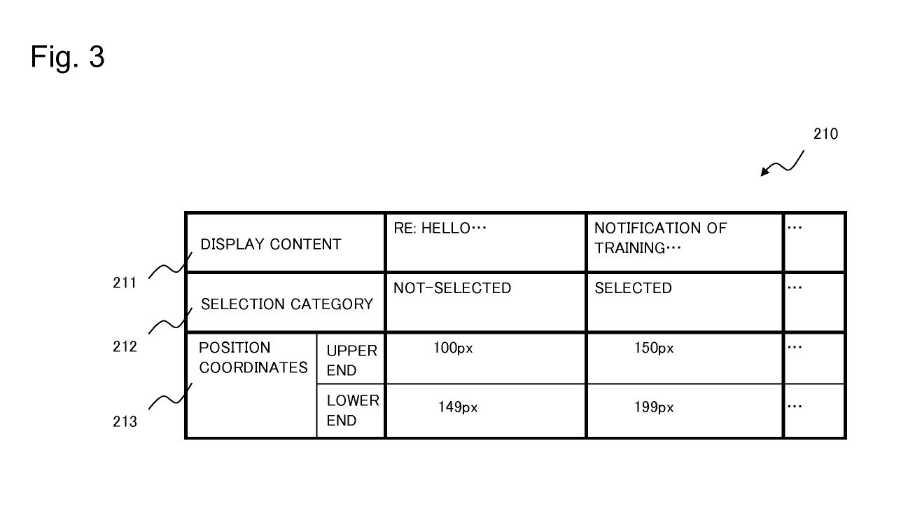

FIG. 3 is a diagram illustrating the item storage unit according to the second exemplary embodiment of the present invention.

The item storage unit 210 includes display contents 211, selection categories 212, and position coordinates 213. That is, the display contents 211, selection categories 212, and position coordinates 213 are associated with one another in the item storage unit 210 as shown in a conceptual table shown in FIG. 3.

The display contents 211 are contents displayed on the display unit 400. In the second exemplary embodiment, the display content 211 is the title, date, and sender of a mail.

The selection category 212 indicates whether or not the item is selected.

The position coordinates 213 indicate a position where each item is displayed. The position coordinates 213 are coordinates that indicate the upper end of the item and coordinates that indicate the lower end thereof. The position coordinates 213 are expressed by the number of pixels (px).

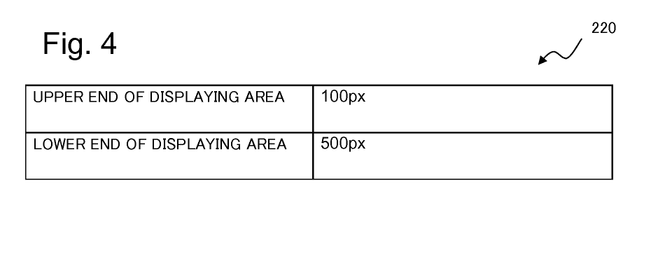

FIG. 4 is a diagram illustrating the display area storage unit according to the second exemplary embodiment of the present invention.

The display area storage unit 220 expresses the coordinates at the upper end and the lower end of the scrollable displaying area in display information with the number of pixels (px). As the upper end of the displaying area is 100 px in FIG. 4, the displaying area is considered to be scrolled by 100 px from the top for the display information. If the height of the displaying area is 400 px, the lower end of the displaying area is 500 px that is obtained by adding the height 400 px to the upper end 100 px.

The concept of display of a list view according to the second exemplary embodiment will be described taking an example of a list view that displays a list of items from “A” to “Z”. This list view can display five items at a time. That is, the displaying area of this list view is the size of five items.

A case where a list view (scrollable displaying area) is scrolled up on the display screen will be described.

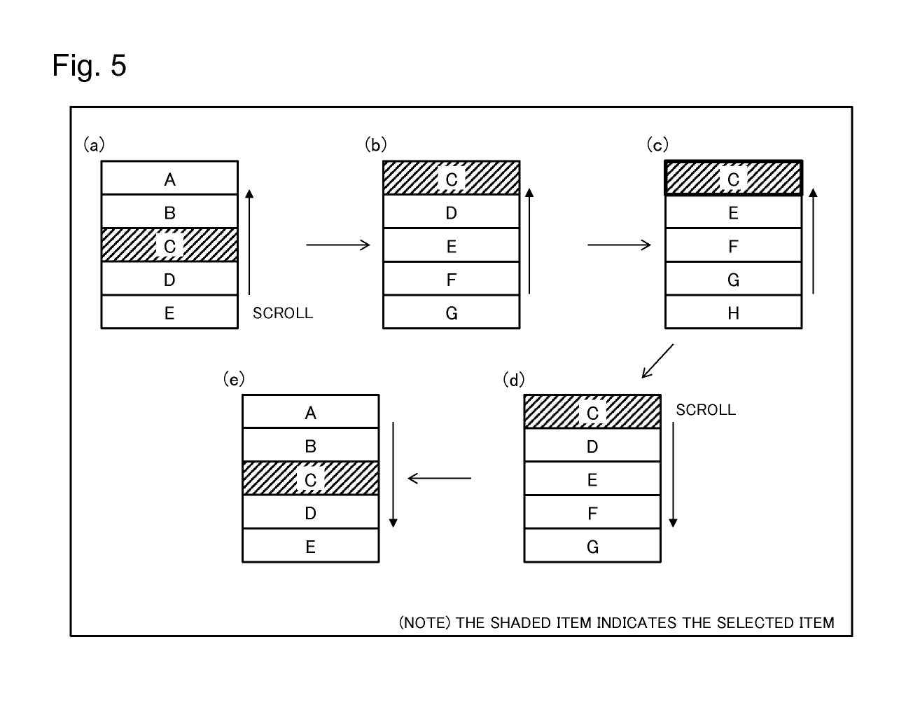

FIG. 5 is a diagram illustrating a concept of display when a list view is scrolled up according to the second exemplary embodiment of the present invention.

First, the display device 100 displays items “A” to “E”. Then, a user selects “C” (refer to list (a) in FIG. 5).

The user scrolls up the list view on the display screen to show “C” on the top (refer to list (b) in FIG. 5).

From this state, by further scrolling up by one item, “C” becomes outside of the scrollable displaying area. However, in the second exemplary embodiment, the display device 100 displays the selected “C” remaining at the upper end. Then, to indicate that “C” is remaining on the display screen, “C” is displayed with bold lines surrounding the item (refer to list (c) in FIG. 5).

Next, by scrolling down by one item, the display position of “C” remains as is and the bold lines that indicated that “C” was remaining at the upper end disappears (refer to list (d) in FIG. 5). The content displayed here is the same content as shown in list (b) in FIG. 5.

By further scrolling down, the remaining state of the item “C” to the upper end is cancelled, and the item “C” moves within the displaying area (refer to list (e) in FIG. 5).

A case where a list view is scrolled down on the display screen will be described.

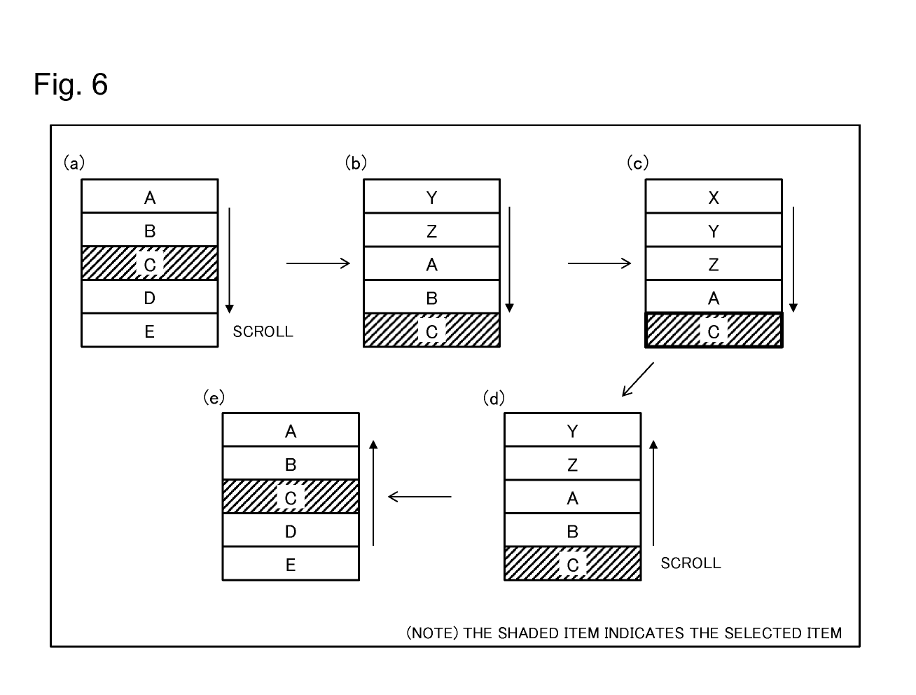

FIG. 6 is a diagram illustrating a concept of display when a list view is scrolled down according to the second exemplary embodiment of the present invention.

First, the display device 100 displays items “A” to “E”. Then, a user selects “C” (refer to list (a) in FIG. 6).

The user scrolls down the list view on the display screen to show “C” on the bottom (refer to list (b) in FIG. 6).

From this state, by further scrolling down by one item, “C” becomes outside of the scrollable displaying area. However, in the second exemplary embodiment, the display device 100 displays the selected “C” remaining at the lower end. Then, to indicate that “C” is remaining on the display screen, “C” is displayed with bold lines surrounding the item. (refer to list (c) in FIG. 6).

Next, by scrolling up by one item, the display position of “C” remains as is and the bold lines that indicated that “C” was remaining at the lower end disappears (refer to list (d) in FIG. 6). The content displayed here is the same content as shown in list (b) in FIG. 6.

By further scrolling up, the remaining state of the item “C” to the lower end is cancelled, and the item “C” moves within the displaying area (refer to list (e) in FIG. 6).

A case where there are a plurality of items that remain at the upper end as described above will be described.

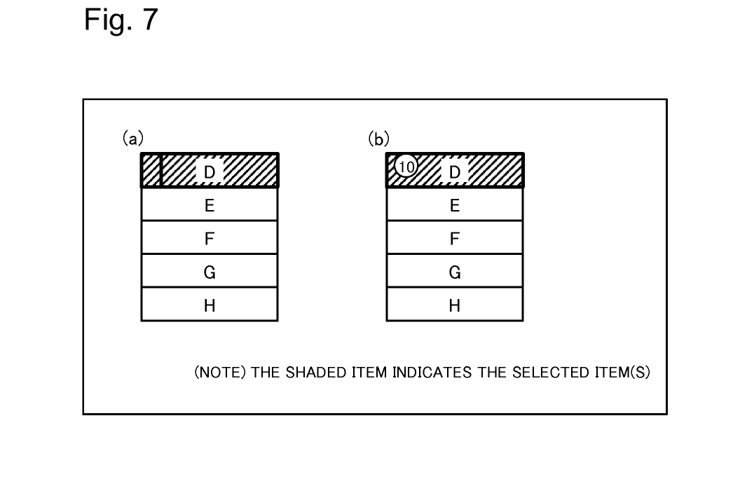

FIG. 7 is a diagram illustrating a concept of display when there are a plurality of items that are displayed by remaining at the upper end according to the second exemplary embodiment of the present invention.

If an item is overlappingly displayed at the same position where another item is displayed by remaining at the upper end of the scrollable displaying area, the overlapped item becomes hidden. As such, the display device 100 displays the items on the display screen in a display format where the display positions are displaced a little in a horizontal direction as shown in list (a) in FIG. 7. In this way, a user can see the existence of selected items and the number of the selected items on the display screen (not shown) of the display unit 400. To that end, a user sets in advance a threshold for the number of items to be displayed with displacements. If the number of items that exceeds the threshold are needed to be displayed at the same position, the display device 100 may, for example, display an item that the user selected the last as a representative item. Further, as shown in list (b) in FIG. 7, the display device 100 displays the number of items that are needed to be displayed at the same position. The list (b) in FIG. 7 shows that ten items are selected. While, in the above example, a case where the items remain at the upper end of the display screen has been described, the same processing applies to the lower end, thus, the description therefor is omitted.

Next, the following will describe the processing flow of the second exemplary embodiment.

The display controlling device 200 acquires information relating to the items to be displayed from the item storage unit 210. The display controlling device 200 gives the position coordinates 213 included in the acquired information and information acquired from the display area storage unit 220 to the display position determination unit 230.

Based on the given information, the display position determination unit 230 determines the display position of each item on the display screen.

The display controlling device 200 generates a content to be displayed in a list view from the determined display position and the display content 211 included in the information acquired from the item storage unit 210. The display controlling device 200 gives the generated content to the display unit 400.

The display unit 400 displays the given list view on the display screen.

A user performs the operation of selecting an item or scrolling the list using the operation unit 300.

If an item is selected, the operation unit 300 informs the display controlling device 200 that operation of selecting an item has done. The display controlling device 200 rewrites the selection category 212 corresponding to the selected item.

Further, if scroll operation is performed, the operation unit 300 informs the display controlling device 200 of the scroll direction and the scroll amount. The display controlling device 200 changes the content of the display area storage unit 220 based on the informed information.

Then, the display controlling device 200 rewrites the content to be displayed in the list view based on the changed content. The display unit 400 displays the content on the display screen. As such, the operation of a user is reflected in the list view displayed on the display screen.

Here, processing for generating a content to be displayed in the list view of the display controlling device 200 will be described.

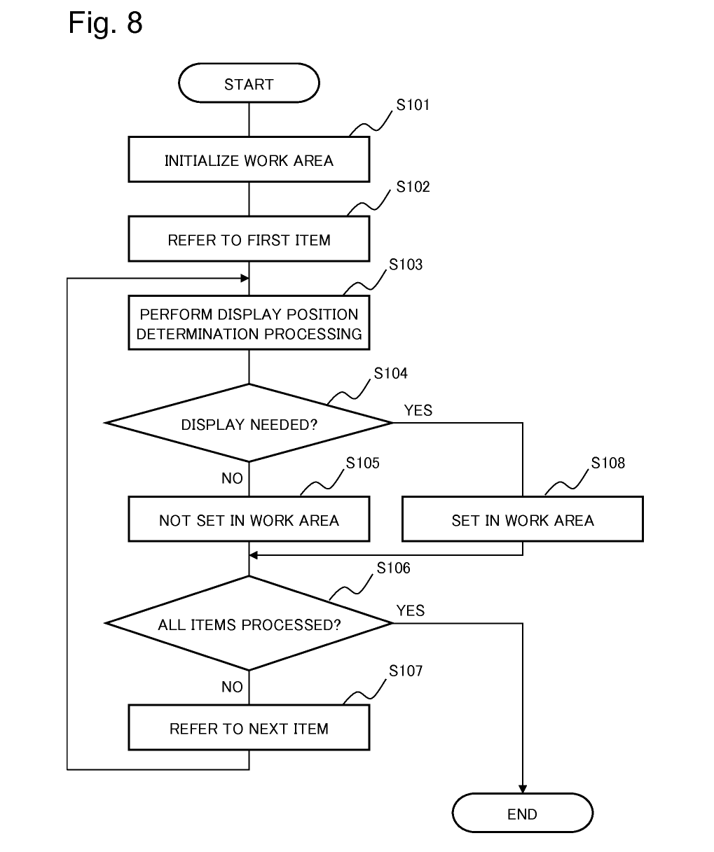

FIG. 8 is a flowchart that indicates the processing of generating a content to be displayed in the display controlling device according to the second exemplary embodiment of the present invention.

The display controlling device 200 prepares a work area (not shown) of the same size as the displaying area and creates a display image in the work area.

First, the display controlling device 200 initializes the work area (step S101).

The display controlling device 200 performs the following processing for all the items stored in the item storage unit 210 in the stored order thereof from the first item.

The display controlling device 200, first, refers to information relating to the first item stored in the item storage unit 210 (step S102).

The display controlling device 200 performs processing for determining the display position by the display position determination unit 230 (step S103). If the display position determination unit 230 returns the processing as display is needed (“Yes” at step S104), the display controlling device 200 sets the display content of the item in the work area based on the display position returned from the display position determination unit 230 (step S108). If the display position determination unit 230 returns the processing as the display is not necessary (“No” at step S104), the item is not required to be displayed on the display screen. Thus, the display controlling device 200 does not set the display content of the item in the work area (step S105).

The display controlling device 200 determines whether the processing has been done for all the items stored in the item storage unit 210 (step S106).

If the processing has been done for all the items (“Yes” at step S106), the display controlling device 200 ends the processing for generating the content to be displayed in the list view. That is, the display controlling device 200 completed creating the image to be displayed on the display screen in the work area.

If the processing has not been done for all the items (“No” at step S106), the display controlling device 200 refers to the item stored next in the item storage unit 210 (step S107). Then, the display controlling device 200 performs the processing from step S103 for the item.

Next, processing for determining the display position in the display position determination unit 230 will be described.

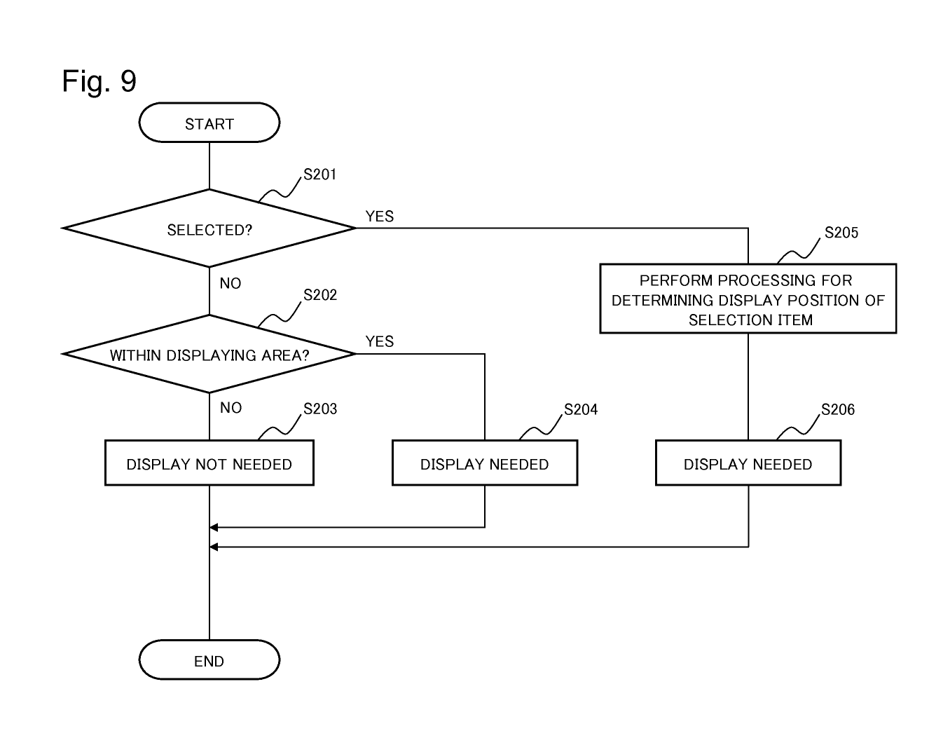

FIG. 9 is a flowchart that indicates processing of determining a display position in the display position determination unit according to the second exemplary embodiment of the present invention.

This processing is performed at S103 where information relating to an item stored in the item storage unit 210 and information stored in the display area storage unit 220 is received from the display controlling device 200.

The display position determination unit 230 determines whether the item is selected based on the selection category 212 stored in the item storage unit 210 (step S201).

If the item is not selected (“No” at step S201), the display position determination unit 230 determines whether the item is within the displaying area based on the position coordinates 213 stored in the item storage unit 210 and the information stored in the display area storage unit 220 (step S202). If the item is within the displaying area (“Yes” at step S202), the display position determination unit 230 returns the processing to the display controlling device 200 as the item is needed to be displayed (step S204). If the item is not within the displaying area (“No” at step S202), the display position determination unit 230 returns the processing to the display controlling device 200 as the item is not needed to be displayed (step S203).

If the item is selected (“Yes” at step S201), the display position determination unit 230 performs processing for determining the display position of the selection item (step S205). Then, the display position determination unit 230 returns the processing to the display controlling device 200 as the item is needed to be displayed (step S206).

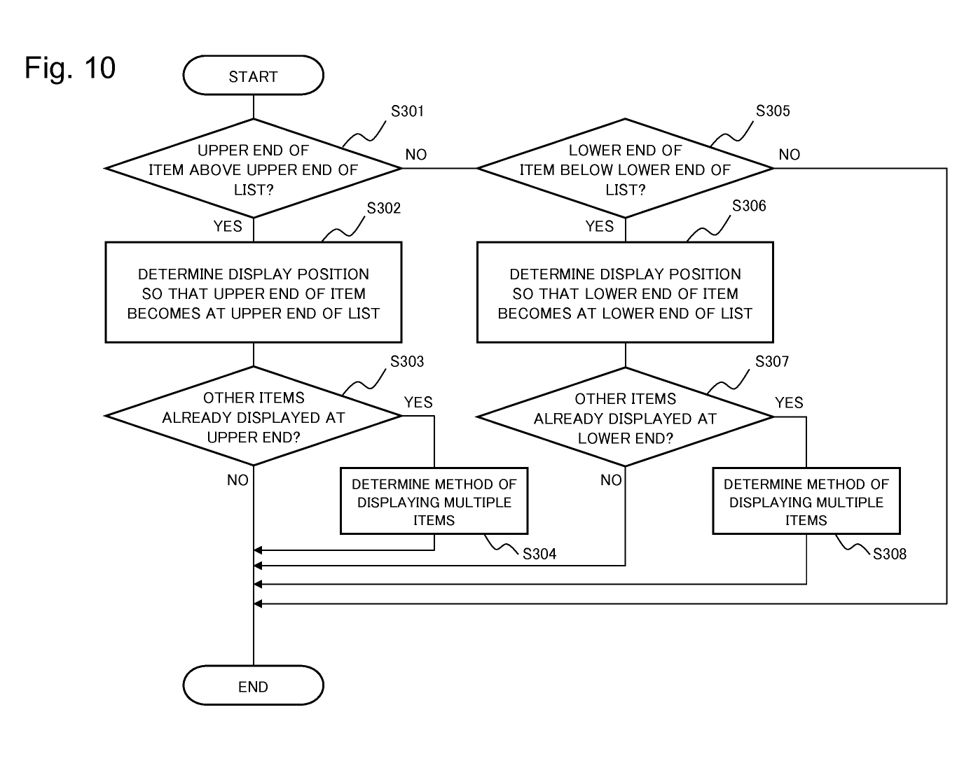

Next, processing of determining the display position of a selection item in the display position determination unit 230 will be described with reference to FIG. 10.

FIG. 10 is a flowchart that indicates processing of determining a display position of a selected item in the display position determination unit according to the second exemplary embodiment of the present invention.

If the position coordinates 213 at the upper end of the selected item is above the position coordinates of the upper end of the displaying area (“Yes” at step S301), the display position determination unit 230 determines the display position of the item so that the upper end of the item becomes the upper end of the display screen (step S302). As such, even if the selected item is scrolled up to push the item outside of the scrollable displaying area, the item is fixed and displayed at the upper end of the display screen. In such a case, the item is displayed, for example, in a display format where the item is enclosed by bold lines. As such, a user can see that the item does not actually reside at the position, yet, is fixed and displayed at the upper end of the display screen.

Likewise, if the position coordinates 213 at the lower end of the selected item is below the position coordinates of the lower end of the displaying area (“Yes” at step S305), the display position determination unit 230 determines the display position of the item so that the lower end of the item becomes the lower end of the display screen (step S306). As such, even if the selected item is scrolled down to push the item outside of the scrollable displaying area, the item is fixed and displayed at the lower end of the display screen. In such a case, the item is displayed, for example, in a display format where the item is enclosed by bold lines. As such, a user can see that the item does not actually reside at the position, yet, is fixed and displayed at the lower end of the display screen.

For convenience of explanation, the second exemplary embodiment has been explained as a processing configuration where an item that is fixed and displayed at the upper end or the lower end of the display screen is displayed by being enclosed by bold lines. However, the present invention that has been explained with an example of the second exemplary embodiment is not limited to such a processing configuration, and the display method is not limited as long as the selected item is distinguishable from other items.

If there is an item that is already displayed at the same position at steps S302 and S306 (“Yes” at step S303 and “Yes” at step S307), the display position determination unit 230 performs processing of determining a method of displaying a plurality of items (steps S304 and S308).

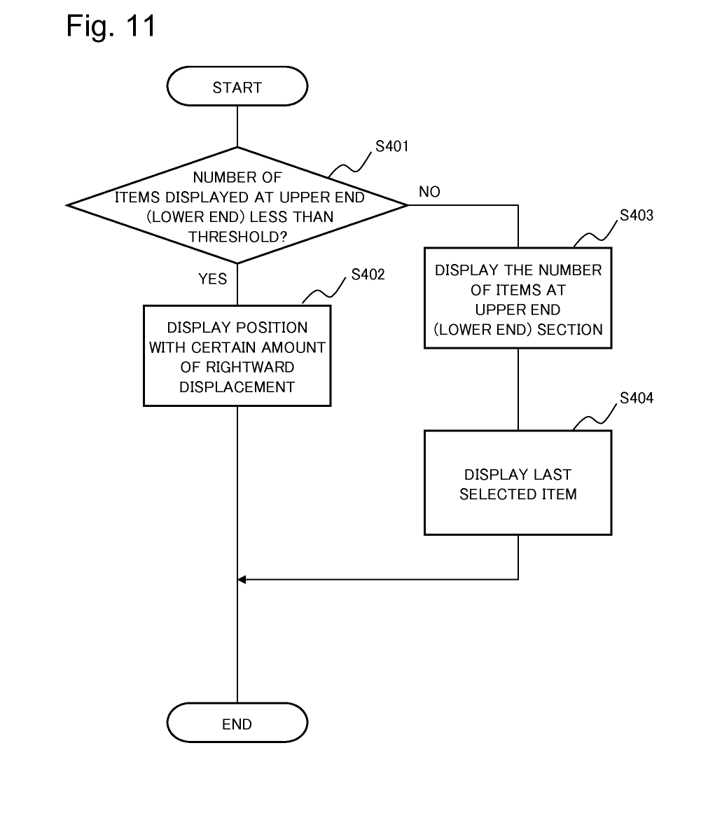

FIG. 11 is a flowchart that indicates processing of determining a method of displaying a plurality of items at the upper end and the lower end of the display screen in the display position determination unit according to the second exemplary embodiment of the present invention.

First, the display position determination unit 230 determines whether the number of items that are displayed either the upper end or the lower end of the display screen is less than the above-described threshold (step S401). If the number of items is less than the threshold (“Yes” at step S401), the display position determination unit 230 determines the display positions with a certain amount of shifts in a rightward direction as shown in list (a) in FIG. 7 (step S402). If the number of items exceeds the threshold (“No” at step S401), the display position determination unit 230 determines, for example, the last selected item as a representative item. Then, the display position determination unit 230 determines to display the representative item and the number of items displayed at the upper end or the lower end (steps S403 and S404).

A user can perform two kinds of operation for the items, of which display positions are fixed.

The one kind of operation is to move the display screen to the position of the selected item in the list (to a display position before fixing the display position). When the display controlling device 200 is informed of the operation, if the operation is to move to the position of the selected item, the display controlling device 200 acquires the position coordinates 213 corresponding to the item from the item storage unit 210. Then, based on the acquired information, the display controlling device 200 changes the content of the display area storage unit 220, for example, so as to position the item at the center of the list view.

The other kind of operation is to cancel the selection. To perform this operation, a user needs to perform operation that is different from a normal course of action, such as a right-click of a mouse. If the operation is the cancellation of selection, the display controlling device 200 changes the selection category 212 of the item in the item storage unit 210 to an unselected state.

Then, the display controlling device 200 rewrites the content to be displayed in a list view according to the changed content. Then, the display unit 400 displays the content on the display screen. As such, the operation of a user is reflected in the list view displayed on the display screen.

While a case where a user selects an item was exemplified in the second exemplary embodiment, the display device 100 may preselect an item all by itself. The display device 100 displays a list view in the same way even if there is an item that is preselected from the items in the list view. That is, if an item selected by the system exists outside of the scrollable displaying area to be displayed by scrolling, the item sticks to the upper end or the lower end of the list view and is displayed on the display screen from the initial display.

In the second exemplary embodiment, a list view that is scrolled in a vertical direction has been explained as an example. However, the present invention, which has been explained with an example of the second exemplary embodiment, is not limited to a list view that is scrolled in a vertical direction, yet, can be applied, for example, to a list view in which items are arranged in a horizontal direction.

Further, the present invention, which has been explained with an example of the second exemplary embodiment, can be applied not only to the list view in which one item in a list is expressed in one row, but also to a list view in which one item is expressed by one icon and icons are arranged in a horizontal direction.

As described above, the second exemplary embodiment has an effect where a user can easily see selected items in a list view without additional operation.

This is because the display device 100 according to the second exemplary embodiment continues to display the selected item within the list view even if scroll operation is performed by a user. In other words, if the selected item (selection item) exists in the displaying area, the display device 100 moves the display position of the selection item by scroll operation. Here, if the upper end or the lower end of the selection item contacts with the upper end or the lower end of the displaying area, the display device 100 performs the following processing. That is, the display device 100 holds the movement of the display position of the selection item in the contact state. Then, while the display position of the selection item continues to be outside of the scrollable displaying area even if the scroll position is further moved, the display device 100 displays the selection item in a display format as if the selected item sticks to the upper end or the lower end of the display screen. In this way, a user can easily see the selected item.

Further, for the item displayed by sticking to the display screen, a user can perform operation of moving to the position of the item or cancellation of the selection. In this way, a user can see which item was selected without scrolling, and, further, easily perform operation for such an item.

### Third Exemplary Embodiment

Next, the following will describe the third exemplary embodiment on the basis of the display device according to the above-described second exemplary embodiment.

The present invention is applicable not only to a list view but also a case of displaying two-dimensional data that can be scrolled in vertical and horizontal directions. The present invention is also effective for a display object, with which two-dimensional positions are treated as important information, such as a map.

As the third exemplary embodiment of the present invention, a case of displaying a map will be described.

The configuration of the third exemplary embodiment is the same as the configuration of the second exemplary embodiment shown in FIG. 2, thus, the explanation therefor is omitted.

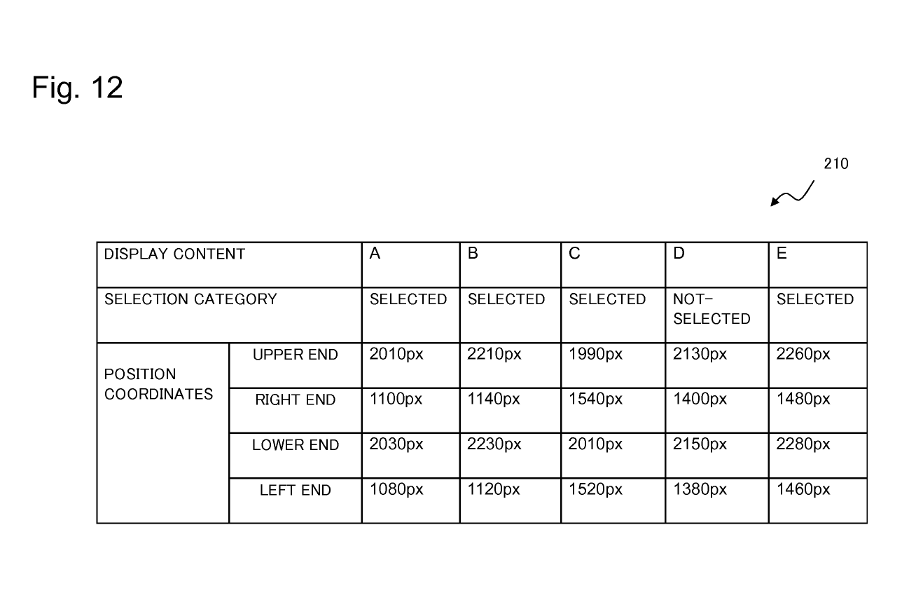

FIG. 12 is a diagram illustrating the item storage unit according to the third exemplary embodiment of the present invention.

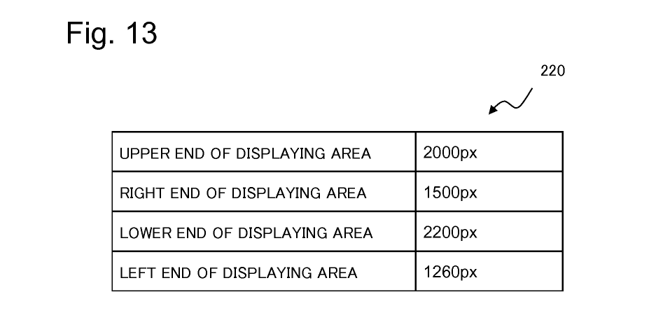

FIG. 13 is a diagram illustrating the display area storage unit according to the third exemplary embodiment of the present invention.

The displaying area of the third exemplary embodiment corresponds to the scrolled position of the map. As the map can be scrolled both in vertical and horizontal directions, as shown in FIG. 13, the display area storage unit 220 includes information that indicates the positions of the right end and the left end in addition to the upper end and the lower end. Likewise, for items displayed on the map, as shown in FIG. 12, the item storage unit 210 includes information that indicates the positions of the right end and the left end in addition to the upper end and the lower end.

When displaying items on the display screen, in the same way as the second exemplary embodiment, the display position determination unit 230 checks whether each item extends outside of the scrollable displaying area. In the second exemplary embodiment, the display position determination unit 230 checks only regarding the vertical direction. However, in the third exemplary embodiment, the display position determination unit 230 further checks regarding the horizontal direction. That is, the display position determination unit 230 needs to check the following four points. First, if the upper end of an item is above the upper end of the displayed map, the upper end of the item is displayed on the display screen so as to be at the upper end of the map. Next, if the lower end of the item is below the lower end of the map, the lower end of the item is displayed on the display screen so as to be at the lower end of the map. Further, if the left end of the item is on the left side of the left end of the map, the left end of the item is displayed on the display screen so as to be at the left end of the map. Finally, if the right end of the item is on the right side of the right end of the map, the right end of the item is displayed on the display screen so as to be at the right end of the map. Checking of the above-described vertical and horizontal four ends was sequentially described as a matter of convenience, without restriction to the checking order.

In the same way as the second exemplary embodiment, when an item that is supposed to extend outside of the scrollable displaying area is displayed by remaining at an end of the display screen, the display device 100 clearly indicates to a user that the item is remaining and displayed, such as, by displaying the frame surrounding the item with bold lines.

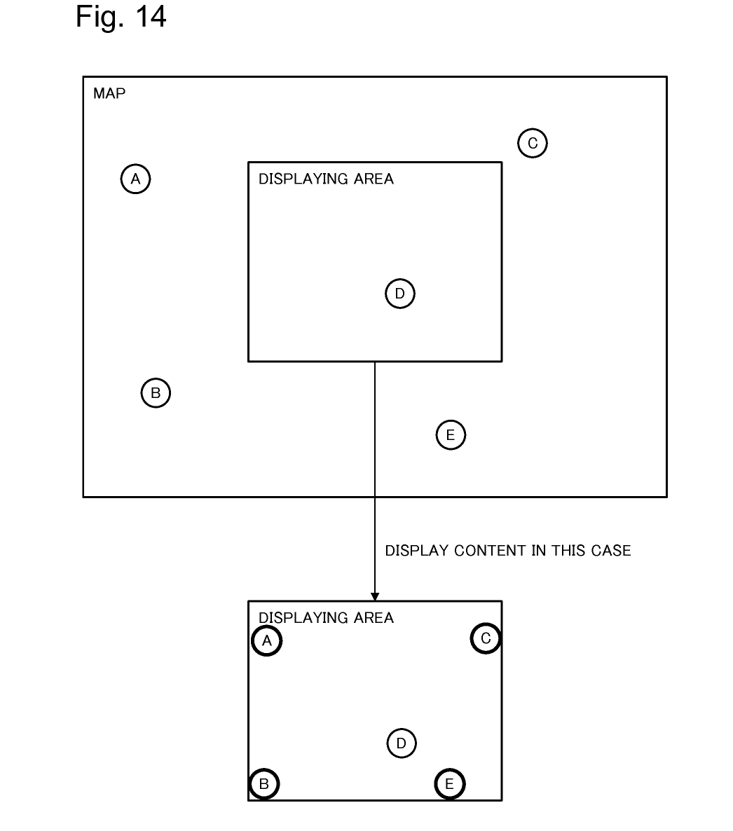

FIG. 14 is a diagram illustrating the concept of display according to the third exemplary embodiment of the present invention.

With reference to FIG. 14, a case of displaying an item “A” will be specifically described.

The display position determination unit 230 performs processing by comparing the contents between the display area storage unit 220 and position coordinates 213 stored in the item storage unit 210. For the upper ends, the display area storage unit 220 is “2000 px” and the position coordinates 213 of the item storage unit 210 is “2010 px”. The result of comparing these values is 2000 px<2010 px. Thus, the upper end of the item “A” is included within the displaying area as the upper end of the item “A” is below the upper end of the map. Likewise, the display position determination unit 230 also performs processing for the lower end, left end, and right end. For the lower end of the item “A,” 2200 px>2030 px. As the lower end of the item is above the lower end of the map, the lower end of the item “A” is included within the scrollable displaying area. For the left end of the item “A,” 1260 px>1080 px. As the left end of the item is on the left side of the left end of the map, the left end of the item “A” is not included within the scrollable displaying area. Thus, the left end of the item “A” is needed to be displayed at the left end of the display screen. For the right end of the item “A,” 1500 px>1100 px. As the right end of the item is on the left side of the right end of the map, the right end of the item “A” is included within the scrollable displaying area.

The horizontal direction of the item “A” extends outside of the scrollable displaying area according to the display based on the position coordinates 213. Therefore, the display device 100 displays the item “A” on the display screen by changing the display position of the item “A” in the horizontal direction as described above.

As described above, the third exemplary embodiment has an effect where, in display of two-dimensional data that can be scrolled in vertical and horizontal directions, a user can easily see the selected item without additional operation.

This is because the display device 100 according to the third exemplary embodiment continues to display the selected item within the display screen even if scroll operation is performed by a user. In other words, if the selected item (selection item) exists in the scrollable displaying area, the display device 100 moves the display position of the selection item by scroll operation. Here, if the upper or lower end or left or right end of the selected item contacts with the upper or lower end or left or right end of the scrollable displaying area, the display device 100 holds the movement of the display position of the selection item in the contact state. Then, while the display position of the selection item continues to be outside of the scrollable displaying area even if the scroll position is further moved, the display device 100 displays the selection item in a display format as if the selected item sticks to the upper or lower end or left or right end of the display screen. In this way, a user can easily see the selected item.

(Hardware Configuration)

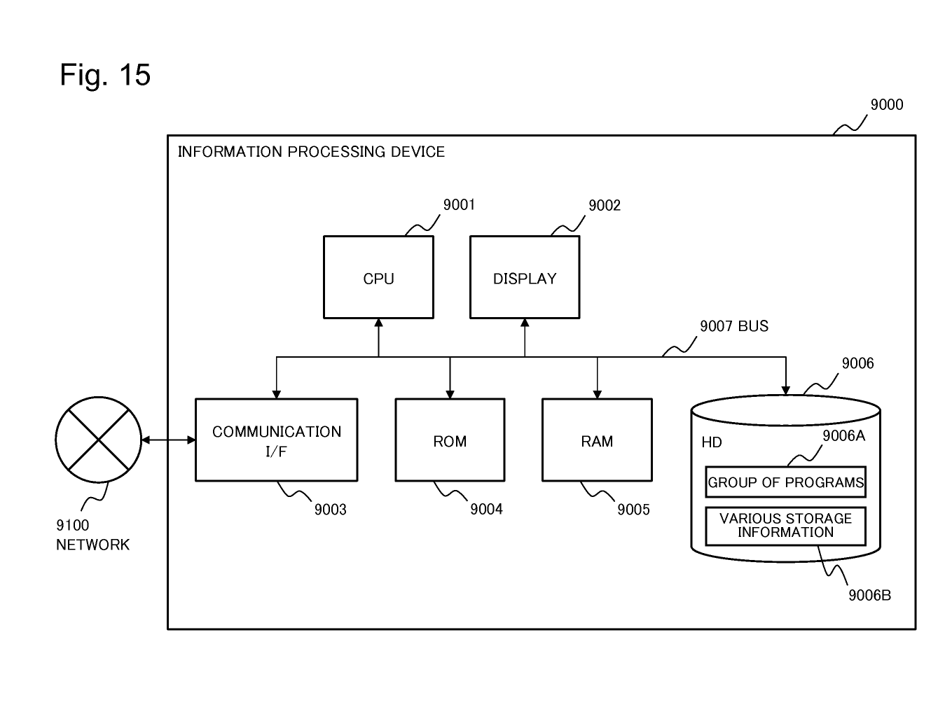

In the above described exemplary embodiments, the respective units shown in FIGS. 1 and 2 may be implemented by dedicated devices, or, otherwise, implemented as functional (processing) units (software modules) of a software program. However, the categorization of the respective units shown in FIGS. 1 and 2 is a structure as a matter of convenience, thus, various structures may be considered for implementation. An example of the hardware environment in such cases will be described with reference to FIG. 15.

FIG. 15 is a exemplary diagram illustrating a hardware configuration of a computer (information processing device) that can implement the first, second, and third exemplary embodiments of the present invention. In other words, FIG. 15 is a computer (information processing device) configuration, which indicates a hardware environment that can implement the respective functions of the above-described exemplary embodiments. This computer can implement a whole or a part of the display controlling device 1 (FIG. 1) or a display device 100 (FIG. 2).

The information processing device 9000 shown in FIG. 15 is a general computer in which the following components are connected through a bus 9007:

a CPU (Central Processing Unit) 9001;

a display 9002;

a communication interface 9003;

a ROM (Read Only Memory) 9004;

a RAM (Random Access Memory) 9005; and

a harddisk device 9006.

The harddisk device 9006 stores a group of programs 9006A and various storage information 9006B. The group of programs 9006A is, for example, a computer program for realizing functions corresponding to the respective blocks (respective units) of the above-described display controlling device 1 (FIG. 1) or display device 100 (FIG. 2). The various storage information 9006B is, for example, the item storage unit 10 and display area storage unit 20 shown in FIG. 1, and the item storage unit 210 and display area storage unit 220 shown in FIG. 2. The communication interface 9003 is common communication means that realizes communications with external devices via the network 9100.

Then, the present invention that has been explained with the above-described exemplary embodiments as examples will be achieved by the following procedure. That is, the information processing device 9000 shown in FIG. 15 is provided with a computer program that can implement the functions shown in the block configuration view and flowcharts (FIGS. 8 to 11) that were referred to in the descriptions of the exemplary embodiments. Thereafter, the computer program is achieved when the CPU 9001 of the hardware reads and executes the computer program. Further, the computer program that is supplied to the information processing device 9000 may be stored in a nonvolatile storage device (a recording medium) such as a readable and writable RAM 9005 or a harddisk device 9006.

Further, in the above-described case, a currently common procedure may be employed for the method of supplying the computer program to the device. For example, the supply method may be a method of installing the computer program to the device via a variety of recording media such as a CD-ROM and a method of downloading the computer program from the outside via a network 9100 such as the Internet. Then, in such a case, the present invention can be considered as being configured by codes that configure the computer program or a recording medium that stores the codes.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### DESCRIPTION OF REFERENCE NUMERALS

1 Display controlling device
2 Screen display device
10 Item storage unit
20 Display area storage unit
30 Display position determination unit
100 Display device
200 Display controlling device
210 Item storage unit
211 Display content
212 Selection category
213 Position coordinates
220 Display area storage unit
230 Display position determination unit
300 Operation unit
400 Display unit
9000 Information processing device
9001 CPU
9002 Display
9003 Communication interface
9004 Rom
9005 Ram
9006 Harddisk device
9006a Group of programs
9006b Various storage information
9007 Bus
9100 Network

1. A display controlling device comprising:
an item storage unit that stores information relating to a plurality of items included in a display content that can be displayed on a display screen of a screen display device;
a display area storage unit that stores information including a scroll amount according to scrolling operation in a scrollable displaying area for displaying the display content, the scrollable displaying area being displayed on the display screen of the screen display device;
a display position determination unit that determines a display position of each of the items based on information stored in the item storage unit and information stored in the display area storage unit,
wherein the display position determination unit determines the display position of each of the items in a display format where, if an item selected from the items stored in the item storage unit is positioned outside of the scrollable displaying area based on the content stored in the display area storage unit to be displayed by scrolling, the item remains at an end of the scrollable displaying area.

2. The display controlling device according to claim 1 wherein, if there are a plurality of items that are displayed by remaining at an end of the scrollable displaying area, and the items are needed to be displayed at a same position, the display position determination unit further determines the display positions of the items in a display format that indicates there are the plurality of items;

3. The display controlling device according to claim 1 wherein, when the display position determination unit determines the display position of the item so that the item remains at an end of the scrollable displaying area, the display controlling device controls the screen display device so that the display position of the item is recognizably displayed on the display screen.

4. A display device comprising:
play controlling device according to claim 1;
a display unit that displays a display content that is generated by the display controlling device; and
an operation unit that informs the display controlling device in response to the operation for the item displayed on the displaying area.

5. A display method performed by an information processing device, comprising:
for a display content that can be displayed on a display screen of a screen display device,
according to scroll operation in a scrollable displaying area for displaying the display content, the scrollable displaying area being displayed on the display screen of the screen display device,
determining a display position of an item in a display format where, if the item selected from items included in the display content is positioned outside of the scrollable displaying area to be displayed by scrolling, the item remains at an end of the scrollable displaying area.

6. A computer-readable non-transitory computer readable medium that stores a computer program,
for a display content that can be displayed on a display screen of a screen display device,
according to scroll operation in a scrollable displaying area for displaying the display content, the scrollable displaying area being displayed on the display screen of the screen display device,
causing a computer to implement a control function that determines a display position of an item in a display format where, if the item selected from items included in the scrollable display content is positioned outside of the scrollable displaying area to be displayed by scrolling, the item remains at an end of the scrollable displaying area.
